(19) United States
(12) Patent Application Publication
(10) Pub. No.: US 2005/0251641 A1
(43) Pub. Date: Nov. 10, 2005

(54) Componentized embedded system information retrieval

(76) Inventors: Anthony Mario Camilli, Cypress, TX (US); Tri Minh Nguyen, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/839,439

(22) Filed: May 5, 2004

(51) Int. Cl. G06F 12/00

(52) U.S. Cl. 711/170

(57) ABSTRACT

Systems, methodologies, media, and other embodiments associated with collecting and providing data items that describe an element of an embedded system configured with a componentized operating system are described. One exemplary system embodiment includes a collection logic configured to collect the data item(s) from the embedded system that is configured with the componentized operating system. The collection logic may store the data item(s) in a data store. The example system may also include an access logic that provides access to the system data collected by the collection logic.

### BACKGROUND

Embedded systems are generally characterized as including a hardware device(s), a compact, reliable operating system that controls a processor(s) in the device, and a set of software applications that run on the operating system. An embedded system is typically a part of a larger system or machine. The compact operating system may be, for example, a componentized version of a larger operating system. Windows XP Embedded is an example of a componentized version of a larger relative, Windows XP Professional. Componentizing an operating system may facilitate minimizing the resource (e.g., memory) demands placed on the hardware by the operating system. Similarly, componentizing an operating system may provide flexibility in deciding what functionality to include in an embedded operating system. However, componentizing an operating system, and then choosing a subset of the available components for the embedded operating system may leave the embedded operating system without some desired functionality. For example, in some componentized implementations, a component like msinfo32.exe that would typically provide access to some system information may not be available. But users, systems administrators, test engineers, and so on, may still want to gather and examine system information about their embedded system.

A “thin client” (e.g., computer with no moving parts), may form the hardware portion of an embedded system. A thin client may include several hardware components like processors, memory, communication devices, and so on. A thin client user may wish to gather system information about their system. A componentized operating system may be used to reduce the footprint (e.g., memory requirements) of the operating system that runs on the thin client. Some of the components that may be left out of a componentized operating system to reduce its footprint on a thin client may include management consoles and system information collection/display utilities with which users are familiar. If some system information collection functionality is included, it may not function properly if file dependencies required to implement the functionality are not satisfied (e.g., required dynamic link library (DLL) missing). Even if system information can be collected, a user may not have a single point of contact with their embedded system through which they can access the system information.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for retrieving system information from an embedded system configured with a componentized operating system.

FIG. 2 illustrates another example system for retrieving system information from an embedded system configured with a componentized operating system.

FIG. 3 illustrates an example method for acquiring and providing system information from an embedded system configured with a componentized operating system.

FIG. 4 illustrates another example method for acquiring and providing system information from an embedded system configured with a componentized operating system.

FIG. 5 illustrates an example computing environment in which example systems and methods illustrated herein can operate.

FIG. 6 illustrates an example application programming interface (API).

FIG. 7 illustrates an example method associated with a graphical user interface (GUI).

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers. An embedded system may include several computer components.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics. An embedded system may include several logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically and/or statically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

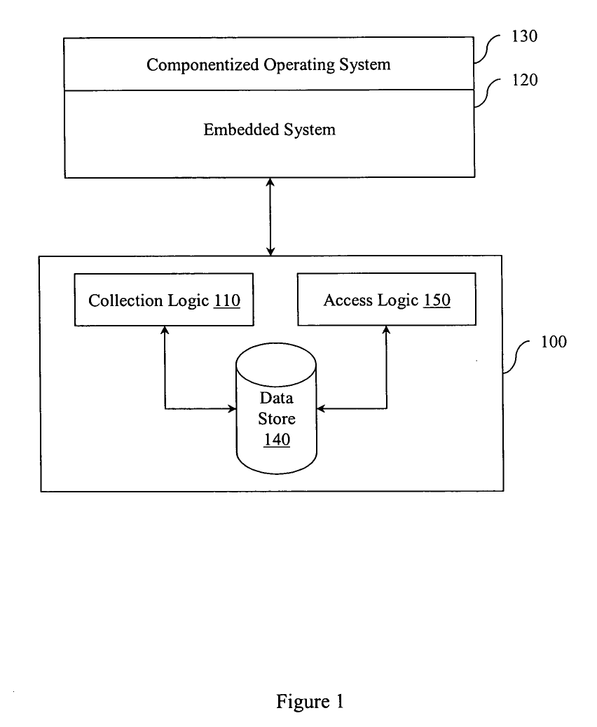

FIG. 1 illustrates a system 100 that includes a collection logic 110 that is configured to collect a system data from an embedded system 120 that is configured with a componentized operating system 130. In one example, embedded system 120 may be a specialized computer system that is part of a larger system or machine. An embedded system may, for example, be housed on a microprocessor board. The board may include a read-only memory (ROM) in which programs run by the embedded system are stored. A microprocessor board that controls an automobile anti-lock brake system is one example of an embedded system. Embedded systems typically respond to events in real time.

The system data may include, for example, information concerning random access memory (RAM) associated with the embedded system 120. The RAM information may include, for example, the amount, type, and/or location of RAM associated with the embedded system 120. While amount, type, and/or location are described, it is to be appreciated that other RAM information may be acquired and/or made available. The system data may also include, for example, information concerning flash memory associated with the embedded system 120. The flash memory information may include, for example, the amount and type of flash memory associated with the embedded system 120 and a name for a logical drive implemented by the flash memory. While amount, type, and logical names for “disk drives” implemented in flash memory are described, it is to be appreciated that other information about flash memory may be acquired, provided, and/or displayed. The system data may also include information concerning the manufacturer (e.g., website address, name, telephone number) of the embedded system 120, a product name assigned to the embedded system 120, a serial number assigned to the embedded system 120, and the like. The system data may also include information concerning read only memory (ROM) associated with the embedded system 120. The ROM information may include, for example, a ROM version, a ROM release date, a ROM manufacture date, a ROM manufacturer, a ROM size, a ROM type, a ROM location, and the like. The system data may also include information concerning the componentized operating system 130, like an operating system version, name, manufacturer, product identifier, system image identifier, version date, and the like. The system data may also include information concerning a hardware device(s) (e.g., network adapter) included in the embedded system 120. The hardware device data may include, for example, a hardware device name, type, address, interrupt vector, power requirement, and so on.

The collection logic 110 may be configured to acquire the system data since the componentized operating system 130 may not include logic to acquire the data. For example, a componentized operating system 130 developed from Microsoft Windows XP Embedded may not include logic for examining the hardware, software, and firmware in the embedded system 120. Even if the componentized operating system 130 includes some such logic, it may not be configured to store the retrieved information in a single location and to provide a single point of contact for a user who desires to access the data. In one example, the collection logic 110 is configured to collect all the types of system data described above. However, in other examples, the collection logic 110 may be configured to collect subsets of the system data. Furthermore, the collection logic 110 may be dynamically reconfigurable to facilitate collecting different subsets of system data under different conditions.

The collection logic 110 may acquire the system data from a variety of elements including hardware, firmware, and/or software associated with the embedded system 120. Thus, the collection logic 110 may interact with various logics to collect the system data. For example, the collection logic 110 may access a system management BIOS (SMBIOS) associated with the embedded system 120 to collect hardware-related management information in a standardized format. The information acquired through the SMBIOS may include, for example, BIOS information (e.g., version, release date), manufacturer and product name strings, processor type information, cache information (e.g., installed size), system slot data (e.g., type, bus width, slot identifier), physical memory information (e.g., location, use, memory error correction, maximum capacity), memory device information, and so on. In one example, the SMBIOS may be an SMBIOS like that described by the Distributed Management Task Force (DMTF) in the SMBIOS version 2.3.4 specification. While the DMTF version 2.3.4 specification is described, it is to be appreciated that in some examples other SMBIOS versions may be employed.

The collection logic 110 may also interact with an application programming interface (API) associated with the componentized operating system 130. For example, the componentized operating system 130 may publish interfaces to various dynamic link libraries (DLLs) that facilitate acquiring a piece of system information. Thus, the collection logic 110 may determine whether there is a published interface, and if so, may employ it to acquire the data. The collection logic 110 may also, for example, examine a registry associated with the componentized operating system 130, examine a file system associated with the componentized operating system 130, examine a file associated with the componentized operating system 130, communicate with a hardware device(s) included in the embedded system 120, and so on. The collection logic 110 may examine the registry to determine, for example, what software applications, if any, have been installed, updated, uninstalled, and so on, on the embedded system.

The collection logic 110 may be configured to store the system data in a data store 140. The data store 140 may be, for example, a file that can be read by a user or by a display application. In one example, the collection logic 110 may store the system data in an XML (extensible markup language) record to facilitate making the data widely available. In another example, the data store 140 may be a memory that is writeable by the collection logic 110 and/or embedded system 120 and readable by a display application. Since an embedded system 120 like an anti-lock brake system may not have a display, the collection logic 110 may store the system data in a location that is accessible to a display application.

The system 100 may also include an access logic 150 that is configured to provide access to the system data stored in the data store 140. The access logic 150 may provide a programmatic interface that facilitates accessing the system data stored in the data store 140. For example, the access logic 150 may publish an interface that facilitates other logics requesting system data stored in the data store 140 without requiring them to become familiar with the internal layout of the data store 140. In one example, the access logic 150 may provide the system data to a support information window in a Microsoft system information control panel applet provided by Microsoft Windows XP Embedded. While the collection logic 110 and the access logic 150 are illustrated outside the embedded system 120, it is to be appreciated that in one example, either the collection logic 110 and/or the access logic 150 may be part of the embedded system 120.

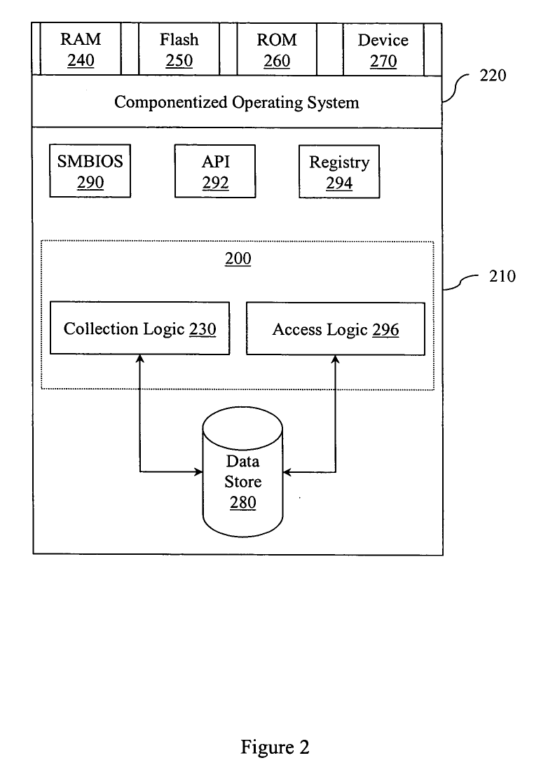

FIG. 2 illustrates a system 200 for retrieving system information from an embedded system 210 that is configured with a componentized operating system 220. The system 200 includes a collection logic 230 that is configured to collect a system data from the embedded system 210. The componentized operating system 220 may be assembled from a set of components available in a parent operating system. For example, the componentized operating system 220 may be derived from a parent operating system like Microsoft Windows XP Embedded. While a single component in a componentized operating system may be able to acquire and/or provide information concerning its operation, components in a componentized operating system typically work independently, making it difficult to coordinate system data collection and providing a single point of contact.

The system data may include information concerning random access memory (RAM) 240 associated with the embedded system 210, flash memory 250 associated with the embedded system 210, read only memory (ROM) 260 associated with the embedded system 210, the componentized operating system 220, hardware device(s) 270 included in the embedded system 210, and so on. The collection logic 220 may be configured to store the system data in a data store 280 after collecting the system data by interacting with a variety of logics. For example, the collection logic 230 may access a system management BIOS (SMBIOS) 290 associated with the embedded system 210, may access an application programming interface (API) 292 associated with the componentized operating system 220, and may examine a registry 294 associated with the componentized operating system 220. Similarly, the collection logic 230 may undertake other actions like examining a file system (not illustrated) associated with the componentized operating system 220, and communicating with a device(s) 270 associated with the embedded system 210. Accessing the SMBIOS 290 may include, for example, reading a formatted data block from a memory associated with the SMBIOS 290. Accessing the API 292 may include, for example, making a procedure call using a procedure entry point defined by the API 292. Examining the registry 294 may include, for example, making a query to a registry database management system.

The system 200 may also include an access logic 296 that is configured to provide the system data to a support information window in a Microsoft system information control panel applet provided by the componentized operating system 220. Since a user may be familiar with the system information control panel, the access logic 296 may select the applet providing the system information control panel for producing an intuitive single point of contact for a user seeking to view the system data.

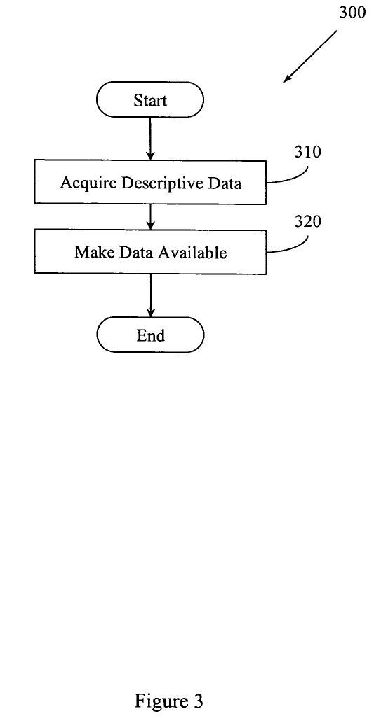

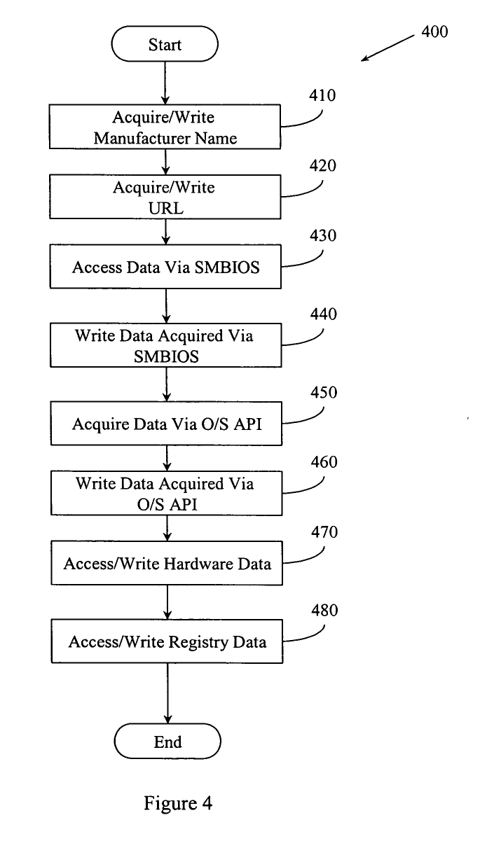

Example methods may be better appreciated with reference to the flow diagrams of FIGS. 3 and 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. The processing blocks may represent a method step and/or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 3 illustrates an example method 300 for acquiring and providing system information from an embedded system configured with a componentized operating system. Embedded systems configured with intact monolithic operating systems likely contain a set of applications and/or utilities designed to collect system information. However, a componentized operating system may not include such utilities. Even if a conventional embedded system does provide for acquiring some system information, it typically does not facilitate providing a user with an intuitive single point of contact for accessing the data.

Thus, the method 300, which may be performed in an embedded system, may include, at 310, acquiring a set of descriptive data from the embedded system. The descriptive data may describe, for example, hardware, software, and/or firmware components of the embedded system. In one example, acquiring the set of descriptive data includes accessing a system management BIOS (SMBIOS) associated with the embedded system, accessing an application programming interface (API) associated with the componentized operating system, examining a registry associated with the componentized operating system, examining a file system associated with the componentized operating system, and communicating with a device included in the embedded system. In other examples, acquiring the set of descriptive data may include performing a subset of the actions described above. Accessing the SMBIOS may involve, for example, making a procedure and/or function call to an SMBIOS provided in the embedded system. Similarly, accessing a componentized operating system API may involve, for example, making a procedure and/or function call to the API to acquire data from the operating system. Examining the registry may include, for example, opening a registry-type file, searching for various entries, and closing the registry-type file. Communicating with a device may include, for example, passing a message to the device, reading a memory-mapped location associated with the device, sending a signal (e.g., interrupt) to the device, and so on.

The method 300 may also include, at 320, making the set of descriptive data available to a user. The set of descriptive data may include, for example, information concerning embedded system random access memory (RAM), embedded system flash memory, the manufacturer of the embedded system, the embedded system product name, the embedded system serial number, embedded system read only memory (ROM), and so on. While several types of system information are described, it is to be appreciated that other system-type data may be acquired and/or displayed by method 300.

In one example, making the set of descriptive data available to a user includes storing the set of descriptive data in a data store. The data store may be, for example, a file that is readable by a user program. In another example, making the set of descriptive data available to a user includes providing the set of descriptive data to a viewing component of the componentized operating system. The viewing component may be, for example, a support information window in a Microsoft system information control panel applet in a componentized operating system derived from Microsoft Windows XP Embedded. In still another example, making the set of descriptive data available to a user includes providing a programmatic interface that facilitates programmatically acquiring the set of descriptive data from the data store.

While FIG. 3 illustrates various actions occurring in serial, it is to be appreciated that various actions illustrated in FIG. 3 could occur substantially in parallel. By way of illustration, a first process could acquire the descriptive data while a second process could make the data available. While two processes are described, it is to be appreciated that a greater and/or lesser number of processes could be employed and that lightweight processes, regular processes, threads, and other approaches could be employed. It is to be appreciated that other example methods may, in some cases, also include actions that occur substantially in parallel.

FIG. 4 illustrates an example method 400 for acquiring and providing system information from an embedded system configured with a componentized operating system. The method 400 facilitates producing a single point of contact for a user to access system information describing elements of the embedded system configured with the componentized operating system. The method 400 may include, at 410, acquiring and selectively writing an embedded system manufacturer data (e.g., name) to a user viewable location. The user viewable location may be, for example, a display window, a file, a memory, and so on. The manufacturer data may be acquired by the method 400 (e.g., by accessing the SMBIOS) and/or may be provided to the method 400. Thus, the method 400 may, in some examples, pull data to it and in other examples may have data pushed to it.

The method 400 may also include, at 420, acquiring and selectively writing an embedded system manufacturer Uniform Resource Locator (URL) to the user viewable location. Like the manufacturer data written at 410, in one example the URL written at 420 may be pulled to the method 400 while in another example the URL may be pushed to the method 400. While a manufacturer name and URL are described, it is to be appreciated that other manufacturer data like address, phone number, and so on, may be acquired and stored (e.g., written).

The method 400 may also include, at 430, retrieving data like a product name, a serial number, a ROM version, a ROM data, and a RAM data for the embedded system via an SMBIOS associated with the embedded system. While five items are described, it is to be appreciated that a greater and/or lesser number of data items may be retrieved via the SMBIOS. At 440, the data acquired at 430 may be selectively written to the user viewable location. Which data is written at 440 may be controlled, for example, by settings in a user preference data.

The method 400 may also include, at 450, acquiring data like an operating system version data and a product identifier data via an application programming interface (API) associated with the componentized operating system. At 460, the data acquired at 450 may be selectively written to the user viewable location. While two items are described, it is to be appreciated that a greater and/or lesser number of data items may be retrieved via the API.

The method 400 may also include, at 470, accessing a hardware device included in the embedded system to acquire a hardware device data. In one example, a networking card may be queried to determine its MAC address and IP address. In another example, a memory card may be queried to determine its size and availability. In yet another example, a mechanical device like a servo that is controlled by the embedded system may be queried to provide data like status, position, and so on. While a network card and a memory card are described, it is to be appreciated that other devices associated with an embedded system may be queried. The information collected at 470 may be selectively written to the user viewable location.

At 480, the method 400 may access a registry associated with the componentized operating system to acquire a pre-installed software data. For example, the registry may contain information concerning which applications, if any, have been pre-installed, installed, updated, uninstalled, and so on, from the embedded system. The information collected at 480 may be selectively written to the user viewable location. “Registry” as used herein refers to the logic and data structures collectively referred to as a registry in the Microsoft operating system environment. For example, a registry may store setup information concerning the hardware, software, and operating system in a system. Information may be stored in a registry, for example, by control panel applications or setup routines associated with various software applications. In one example, a registry is examined using the regedit utility.

In one example, methodologies are implemented as processor executable instructions and/or operations stored on a computer-readable medium. Thus, in one example, a computer-readable medium may store processor executable instructions operable to perform a method performed by an embedded system configured with a componentized operating system derived from Microsoft Windows XP Embedded. The method may include acquiring a set of descriptive data from the embedded system by accessing a system management BIOS (SMBIOS) associated with the embedded system, accessing an application programming interface (API) associated with the componentized operating system, examining a registry associated with the componentized operating system, examining a file system associated with the componentized operating system, and communicating with a device included in the embedded system. The set of descriptive data that is acquired may include information concerning random access memory (RAM) associated with the embedded system, flash memory associated with the embedded system, an embedded system manufacturer, a product name for the embedded system, a serial number for the embedded system, read only memory (ROM) associated with the embedded system, a hardware device(s) included in the embedded system, and so on. The method may also include making the set of descriptive data available to a user by, for example, providing the set of descriptive data to a viewing component of the componentized operating system and providing a programmatic interface that facilitates acquiring the set of descriptive data from the data store. While the above method is described being stored on a computer-readable medium, it is to be appreciated that other example methods described herein can also be stored on a computer-readable medium.

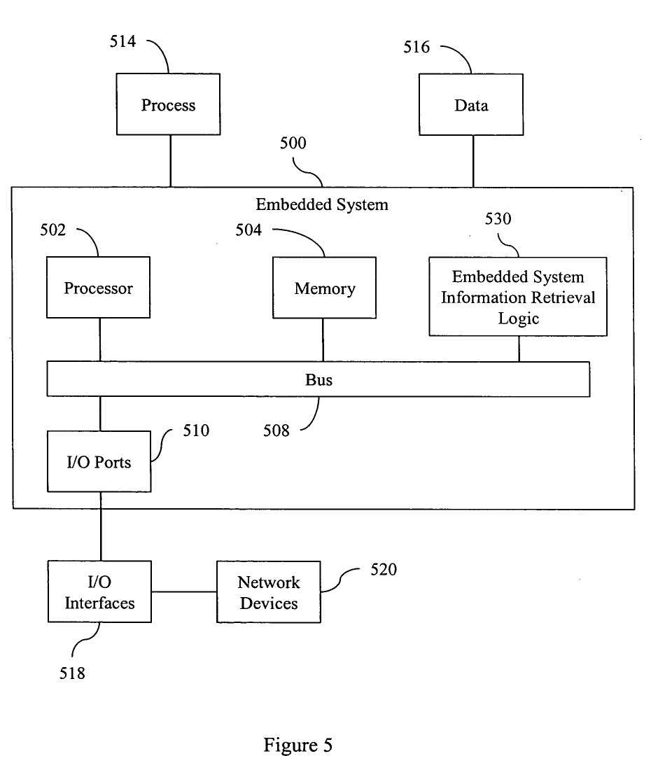

FIG. 5 illustrates an embedded system 500 configured with a componentized operating system. The system 500 includes a processor 502, a memory 504, and input/output ports 510 operably connected by a bus 508. In one example, the embedded system 500 may include a componentized embedded system information retrieval logic 530 configured to facilitate acquiring and providing system information about various components of embedded system 500. Thus, the componentized embedded system information retrieval logic 530, whether implemented in embedded system 500 as hardware, firmware, software, and/or a combination thereof, may provide means for acquiring a hardware data from the embedded system 500. The hardware data may describe a hardware component (e.g., processor 502) of the embedded system 500. The componentized embedded system information retrieval logic 530 may also provide means for acquiring a firmware data from the embedded system 500, where the firmware data describes a firmware component (e.g., ROM BIOS) of the embedded system 500, and means for acquiring a software data from the embedded system 500, where the software data describes a software component (e.g., application running as process 514) of the embedded system 500. While the componentized embedded system information retrieval logic 530 may acquire the hardware, firmware, and software data, it may also provide means for providing the hardware data, the firmware data, and the software data to a single location accessible by a user. For example, the componentized embedded system information retrieval logic 530 may place the hardware, firmware, and software data into a file that can be read by a user (e.g., an XML file), may deliver the data to a viewing applet, may store the data in a memory that can be accessed by an API, and so on.

The processor 502 can be a variety of various processors including dual microprocessor and other multi-processor architectures. The memory 504 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

The memory 504 can store processes 514 and/or data 516, for example. The memory 504 can store a componentized operating system that controls and allocates resources of the embedded system 500. The componentized operating system may be derived from (e.g., built from) Windows XP Embedded, for example. In one example, the embedded system information retrieval logic 530 may be configured to acquire/provide data (e.g., size, type, location) concerning elements like memory 504.

The bus 508 can be a single internal bus interconnect architecture and/or other bus or mesh architectures. While a single bus is illustrated, it is to be appreciated that embedded system 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The embedded system 500 can operate in a network environment and thus may be connected to network devices 520 via the i/o interfaces 518, and/or the i/o ports 510. Through the network devices 520, the embedded system 500 may interact with a network. Through the network, the embedded system 500 may be logically connected to remote computers. The networks with which the embedded system 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 520 can connect to WAN technologies including, but not limited to, point to point links, circuit switching networks like integrated services digital networks (ISDN), packet switching networks, and digital subscriber lines (DSL). In one example, the embedded system information retrieval logic 530 may be configured to acquire data (e.g., MAC address, IP address) from the network devices 520. In another example, the embedded system information retrieval logic 530 may be configured to store system data and make it available to remote computers via the network devices 520.

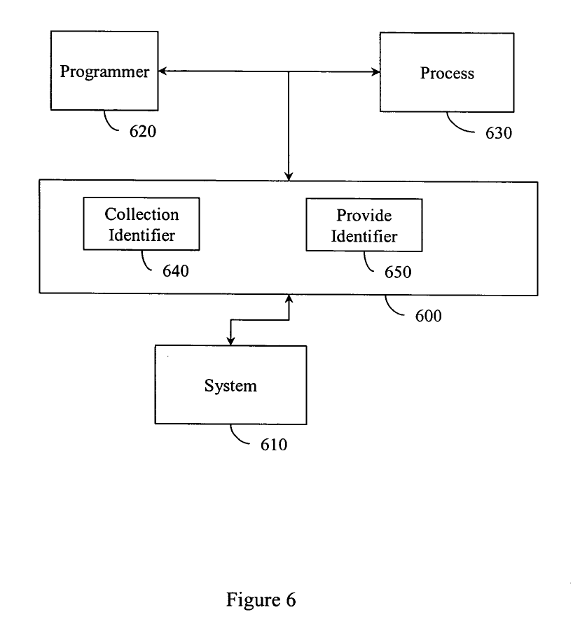

Referring now to FIG. 6, an application programming interface (API) 600 is illustrated providing access to a system 610 for acquiring and providing system information associated with an embedded system configured with a componentized operating system. The API 600 can be employed, for example, by a programmer 620 and/or a process 630 to gain access to processing performed by the system 610. For example, a programmer 620 can write a program to access the system 610 (e.g., invoke its operation, monitor its operation, control its operation) where writing the program is facilitated by the presence of the API 600. Rather than programmer 620 having to understand the internals of the system 610, the programmer 620 merely has to learn the interface to the system 610. This facilitates encapsulating the functionality of the system 610 while exposing that functionality. Similarly, the API 600 can be employed to provide data values to the system 610 and/or retrieve data values from the system 610. For example, a process 630 that acquires system information can provide it to the system 610 via the API 600 by, for example, using a call provided in the API 600.

In one example, a set of application programming interfaces can be stored on a computer-readable medium. The interfaces can be employed by a programmer, logic, and so on, to gain access to a system 610 for acquiring and providing system information associated with an embedded system that is configured with a componentized operating system. The interfaces can include, but are not limited to, a first interface 640 that communicates a first identifier that identifies a system data to collect and a second interface 650 that communicates a second identifier that identifies a system data to provide. For example, the first identifier may indicate that information concerning RAM associated with an embedded system is to be acquired. There may be several pieces of information about RAM available (e.g., size, speed, type, logic) that can be acquired with a single SMBIOS call. Thus, the second identifier may facilitate selecting one element of the acquired data (e.g., RAM size) to provide.

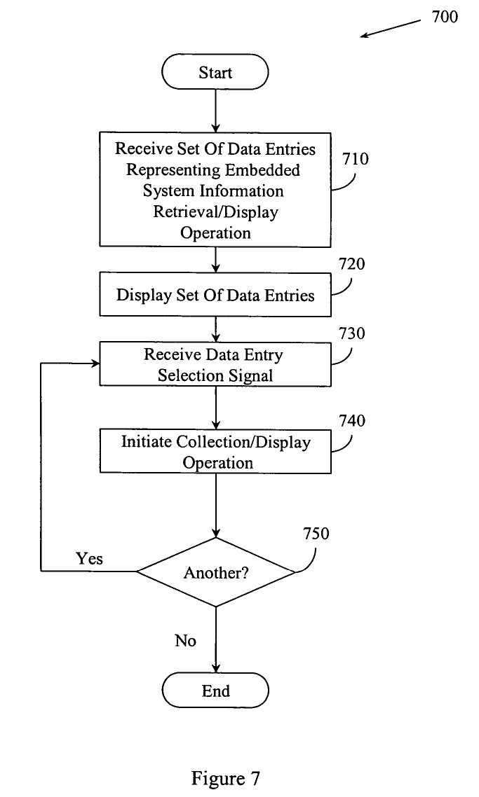

FIG. 7 illustrates an example method 700 concerning operations associated with collecting and displaying a data item(s) that describes an element of an embedded system configured with a componentized operating system. The method 700 may be performed in a computer system having a graphical user interface that includes a display and a selection device. The method 700 may include providing and selecting from a set of data entries on the display. Thus, in one example, the method 700 may include, at 710, retrieving a set of data entries, where a data entry represents an operation associated with collecting and/or displaying the data item that describes an embedded system element (e.g., RAM, processor, operating system, loaded applications). The method 700 may also include, at 720, displaying the set of data entries on the display and, at 730, receiving a data entry selection signal indicative of the selection device selecting an entry. For example, a user may indicate that of twenty possible pieces of system information, a subset of ten items is to be acquired and displayed. The data entry selection signal may be received in response to, for example, a mouse click, a key press, a voice command, and so on. At 740, in response to the data entry selection signal, the method 700 may initiate a data collection and/or display operation associated with the selected data entry. In one example, a determination is made at 750 concerning whether another data entry selection signal is to be processed. If the determination is Yes, then processing returns to 730, otherwise, method 700 may complete. Thus, the method 700 may facilitate identifying system information to acquire and/or display. For example, the method 700 may facilitate displaying a set of system information that can be acquired, selectively acquiring a selected subset of the set of system information, and providing the acquired system information to an applet tasked with displaying the data.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system, comprising:
a collection logic configured to collect a system data from an embedded system configured with a componentized operating system and to store the system data in a data store; and
an access logic configured to provide access to the system data stored in the data store.

2. The system of claim 1, where the system data includes information concerning random access memory (RAM) associated with the embedded system, flash memory associated with the embedded system, an embedded system manufacturer, a product name for the embedded system, a serial number for the embedded system, read only memory (ROM) associated with the embedded system, the componentized operating system, and a hardware device included in the embedded system.

3. The system of claim 2, where information concerning RAM associated with the embedded system includes information about one or more of, an amount of RAM associated with the embedded system, a type of RAM associated with the embedded system, and a location of RAM associated with the embedded system.

4. The system of claim 2, where information concerning flash memory associated with the embedded system includes information about one or more of, an amount of flash memory associated with the embedded system, a type of flash memory associated with the embedded system, and a name for a logical drive implemented in the flash memory.

5. The system of claim 2, where information concerning an embedded system manufacturer includes information about one or more of, a manufacturer website address, a manufacturer name, and a manufacturer telephone number.

6. The system of claim 2, where information concerning ROM associated with the embedded system includes information about one or more of, a ROM version, a ROM release date, a ROM manufacture date, a ROM manufacturer, a ROM size, a ROM type, and a ROM location.

7. The system of claim 2, where information concerning the componentized operating system includes information about one or more of, an operating system version, an operating system name, an operating system manufacturer, an operating system product identifier, an operating system image identifier, and an operating system date.

8. The system of claim 2, where information concerning a hardware device included in the embedded system includes information about one or more of, a hardware device name, a hardware device type, a hardware device address, a hardware device interrupt vector, and a hardware device power requirement.

9. The system of claim 1, where the system data includes information concerning two or more of, random access memory (RAM) associated with the embedded system, flash memory associated with the embedded system, an embedded system manufacturer, a product name for the embedded system, a serial number for the embedded system, read only memory (ROM) associated with the embedded system, the componentized operating system, and a hardware device included in the embedded system.

10. The system of claim 2, where the collection logic is configured to collect the system data by accessing a system management BIOS (SMBIOS) associated with the embedded system, by accessing an application programming interface (API) associated with the componentized operating system, by examining a registry associated with the componentized operating system, by examining a file system associated with the componentized operating system, by examining a file associated with the componentized operating system, and by communicating with a hardware device associated with the embedded system.

11. The system of claim 9, where the collection logic is configured to collect the system data by performing two or more of, making a call to a system management BIOS (SMBIOS) associated with the embedded system, by making a call to an application programming interface (API) associated with the componentized operating system, by examining a registry associated with the componentized operating system, by examining a file system associated with the componentized operating system, by examining a file associated with the componentized operating system, and by communicating with a device associated with the embedded system.

12. The system of claim 1, where the collection logic stores the system data as an XML file in the data store.

13. The system of claim 1, where the access logic provides a programmatic interface that facilitates accessing the system data stored in the data store.

14. The system of claim 1, where the collection logic and the access logic are hardware components forming part of the embedded system.

15. The system of claim 1, the componentized operating system being Microsoft Windows XP Embedded.

16. The system of claim 15, where the access logic provides the system data to a support information window in a Microsoft system information control panel applet provided by Microsoft Windows XP Embedded.

17. A system, comprising:
a collection logic configured to collect a system data from an embedded system configured with a componentized operating system derived from Microsoft Windows XP Embedded, where the system data includes information concerning random access memory (RAM) associated with the embedded system, flash memory associated with the embedded system, an embedded system manufacturer, a product name for the embedded system, a serial number for the embedded system, read only memory (ROM) associated with the embedded system, an operating system associated with the embedded system, and a hardware device included in the embedded system, where the collection logic is configured to store the system data in a data store;
where the collection logic is also configured to collect the system data by accessing a system management BIOS (SMBIOS) associated with the embedded system, by accessing an application programming interface (API) associated with the componentized operating system, by examining a registry associated with the componentized operating system, by examining a file system associated with the componentized operating system, and by communicating with a device associated with the embedded system; and
an access logic configured to provide the system data to a support information window in a Microsoft system information control panel applet provided by the componentized operating system.

18. A computer-executable method performed in an embedded system, comprising:
acquiring a set of descriptive data from the embedded system, where the embedded system is configured with a componentized operating system, and where the descriptive data describes a hardware, software, or firmware component of the embedded system; and
making the set of descriptive data available to a user.

19. The method of claim 18, where acquiring the set of descriptive data includes accessing a system management BIOS (SMBIOS) associated with the embedded system, accessing an application programming interface (API) associated with the componentized operating system, examining a registry associated with the componentized operating system, examining a file system associated with the componentized operating system, and communicating with a device included in the embedded system.

20. The method of claim 18, where acquiring the set of descriptive data includes performing two or more of, accessing a system management BIOS (SMBIOS) associated with the embedded system, accessing an application programming interface (API) associated with the componentized operating system, examining a registry associated with the componentized operating system, examining a file system associated with the componentized operating system, and communicating with a device included in the embedded system.

21. The method of claim 18, where the set of descriptive data includes information concerning random access memory (RAM) associated with the embedded system, flash memory associated with the embedded system, an embedded system manufacturer, a product name for the embedded system, a serial number for the embedded system, read only memory (ROM) associated with the embedded system, an operating system associated with the embedded system, and a hardware device included in the embedded system.

22. The method of claim 18, where making the set of descriptive data available to a user includes storing the set of descriptive data in a data store as an extensible markup language (XML) file.

23. The method of claim 18, where making the set of descriptive data available to a user includes providing the set of descriptive data to a viewing component of the componentized operating system.

24. The method of claim 23, where the viewing component comprises a support information window in a Microsoft system information control panel applet in a componentized operating system derived from Microsoft Windows XP Embedded.

25. The method of claim 18, where making the set of descriptive data available to a user includes providing a programmatic interface that facilitates programmatically acquiring the set of descriptive data from the data store.

26. A computer-readable medium storing processor executable instructions operable to perform a method in an embedded system configured with a componentized operating system, the method comprising:
acquiring a set of descriptive data from the embedded system by accessing a system management BIOS (SMBIOS) associated with the embedded system, accessing an application programming interface (API) associated with the componentized operating system, examining a registry associated with the componentized operating system, examining a file system associated with the componentized operating system, and communicating with a device included in the embedded system, where the set of descriptive data includes information concerning random access memory (RAM) associated with the embedded system, flash memory associated with the embedded system, an embedded system manufacturer, a product name for the embedded system, a serial number for the embedded system, read only memory (ROM) associated with the embedded system, an operating system associated with the embedded system, and a hardware device included in the embedded system; and
making the set of descriptive data available to a user by one or more of, providing the set of descriptive data to a viewing component of the componentized operating system, providing a programmatic interface that facilitates acquiring the set of descriptive data from a data store, and storing the set of descriptive data in an XML file.

27. A method for producing a single point of contact for a user to access system information describing elements of an embedded system configured with a componentized operating system, the method comprising:
selectively writing an embedded system manufacturer data to a user viewable location;
retrieving a product name, a serial number, a ROM version, a ROM data, and a RAM data for the embedded system via an SMBIOS associated with the embedded system;
selectively writing the product name, serial number, ROM version, ROM data, and RAM data to the user viewable location;
acquiring an operating system version data and a product identifier data via an application programming interface (API) associated with the componentized operating system;
selectively writing the operating system version data and the product identifier data to the user viewable location;
accessing a hardware device included in the embedded system to acquire a hardware device data;
selectively writing the hardware device data to the user viewable location;
accessing a registry associated with the componentized operating system to acquire a software data; and
selectively writing the software data to the user viewable location.

28. The method of claim 26, where the user viewable location is a file accessible by a viewing logic.

29. The method of claim 26, where the hardware device data includes a media access control (MAC) address and an Internet Protocol (IP) address.

30. A computer-readable medium storing processor executable instructions operable to perform a method for producing a single point of contact for a user to access system information describing elements of an embedded system configured with a componentized operating system, the method comprising:
selectively writing an embedded system manufacturer data to a user viewable location;
retrieving a product name, a serial number, a ROM version, a ROM data, and a RAM data for the embedded system via an SMBIOS associated with the embedded system;
selectively writing the product name, serial number, ROM version, ROM data, and RAM data to the user viewable location;
acquiring an operating system version data and a product identifier data via an application programming interface (API) associated with the componentized operating system;
selectively writing the operating system version data and the product identifier data to the user viewable location;
accessing a hardware device included in the embedded system to acquire a hardware device data;
selectively writing the hardware device data to the user viewable location;
accessing a registry associated with the componentized operating system to acquire a software data; and
selectively writing the software data to the user viewable location.

31. A system, comprising:
means for acquiring a hardware data from an embedded system configured with a componentized operating system, where the hardware data describes a hardware component of the embedded system;
means for acquiring a firmware data from the embedded system, where the firmware data describes a firmware component of the embedded system;
means for acquiring a software data from the embedded system, where the software data describes a software component of the embedded system; and
means for providing the hardware data, the firmware data, and the software data to a single location accessible by a user.

32. In a computer system having a graphical user interface comprising a display and a selection device, a method of providing and selecting from a set of data entries on the display, the method comprising:
retrieving a set of data entries, where a data entry represents an operation associated with collecting and displaying a data item that describes an element of an embedded system configured with a componentized operating system;
displaying the set of data entries on the display;
receiving a data entry selection signal indicative of the selection device selecting a selected data entry; and
in response to the data entry selection signal, initiating an operation associated with the selected data entry.

33. A set of application programming interfaces embodied on a computer-readable medium for execution by a computer component in conjunction with collecting and providing a system data that describes a component of an embedded system configured with a componentized operating system, comprising:
a first interface for communicating a first identifier that identifies a system data to collect; and
a second interface for communicating a second identifier that identifies a system data to provide.
